(19) United States
(12) Patent Application Publication
(10) Pub. No.: US 2002/0080341 A1
(43) Pub. Date: Jun. 27, 2002

(54) Flow cytometer

(75) Inventor: Tokihiro Kosaka, Kakogawa city (JP)

Correspondence Address: BRINKS HOFER GILSON & LIONE, P.O. BOX 10395, CHICAGO, IL, 60610, US

(73) Assignee: Sysmex Corporation

(21) Appl. No.: 10/025,022

(22) Filed: Dec. 19, 2001

(30) Foreign Application Priority Data
Dec. 22, 2000 (JP) 2000-391182

(51) Int. Cl. G01N 21/69

(52) U.S. Cl. 356/73

(57) ABSTRACT

A flow cytometer includes a sheath flow cell for forming a sample solution flow by surrounding sample solution containing particles with sheath liquid, a light source for radiating light to the sample solution flow, a detecting part for detecting optical information from particles contained in the sample solution flow and converting it to electric signals, and a signal processing part for extracting fluctuation signals from the electric signals which the detecting part outputs.

### CROSS-REFERENCE TO RELATED APPLICATION

This application relates to Japanese Patent Application No. 2000-391182 filed on Dec. 22, 2000 whose priority is claimed under 35 USC §119, the disclosure of which is incorporated by reference in its entirety.

### BACKGROUND

1. Field of the Invention

The invention relates to a flow cytometer, more particularly, to a flow cytometer for analyzing particles such as tissue, blood cells and bacteria.

2. Related Art

A flow cytometer has been conventionally used as a device for analyzing the type and ratio of particles contained in sample solutions. A typical flow cytometer guides sheath liquid and sample solutions which were appropriately diluted and dyed in advance to a sheath flow cell. In the flow cell, the sheath liquid flows surrounding the sample solution flow, and make the sample solution flow stream thin. And laser light is radiated to the flow of the sample solution. Every time a particle passes through the laser light radiated area, scattered light and fluorescence are generated by the particle. The generated scattered light and fluorescence are photoelectrically converted by a photodiode and photo-multiplier tube, and the pulse-like detection signal is obtained for every particle. Counting and classification of particles are carried out by extracting the peak level and pulse width as parameters from the detection signals for respective particles. FIG. 15 shows an aspect of a signal which detected particles, wherein the vertical axis expresses voltage, and the horizontal axis expresses time. Assuming that a particle is detected when exceeding a certain signal level (threshold), the peak level H (light intensity) and pulse width W (light emission duration) are calculated. Such flow cytometers are disclosed in U.S. Pat. No. 5,731,867 and U.S. Pat. No. 5,757,475.

A typical flow cytometer often employs a syringe driven by a stepping motor to deliver the sample solution or sheath liquid to the sheath flow cell. This is because the delivery quantity of the liquid is proportional to the rotating angle of the stepping motor, and the analyzing volume of the sample solution to be analyzed can be confirmed by control of the rotating angle of the stepping motor. U.S. Pat. No. 6,183,697 discloses a flow cytometer employing a stepping motor and syringe for delivering the liquid.

However, as the stepping motor rotates in units of step angles such as 1.80 or 0.90, it does not rotate smoothly without vibration. Therefore, in the method for delivering liquid by use of a stepping motor, flow of the sample solution slightly changes for every rotation of one step, and pulsating flows are generated.

When the pulsating flows are generated in the flow of the sample solution in this way, baselines of the detection signal of the scattered light and fluorescence fluctuates in synchronization with this pulsating flows if the refractive index of the sample solution to be measured differs from that of the sheath liquid. That is, the detection signal includes fluctuation signals.

The fluctuation signal is generally a low frequency signal ranging from 10 Hz through several hundreds of Hz. When such a fluctuation signal is generated, the signal may be mistakenly sensed as a particle detection signal. Further, the fluctuation signal and inherent particle detection signal may overlap each other, with the result that the peak level and pulse width of the particle detection signal may not be correctly obtained. In particular, when measuring fine particles with a diameter of approximately 1 μm, it is necessary to make the amplification factor against the detection signal large; therefore, the fluctuation signal becomes more conspicuous.

### SUMMARY

This invention has been made under consideration of the above drawbacks, and provides a flow cytometer mounting a signal processing function for efficiently eliminating or reducing the fluctuation signal of a low frequency caused by pulsating flows of sample solution or sheath liquid, and the difference in the refractive index between a sample solution and sheath liquid.

### BRIEF DESCRIPTION OF THE DRAWINGS

FIG. 1 shows a schematic configuration of an embodiment according to this invention.

FIG. 2 is a cross-sectional view of the sheath flow cell used in an embodiment according to this invention.

FIG. 3 shows a schematic configuration of a fluid system of the embodiment according to this invention.

FIG. 4 is a waveform diagram showing an example of fluctuation of a baseline in a particle detection signal.

FIG. 5 is a block diagram showing a basic configuration for a signal processing circuit used in an embodiment according to this invention.

FIG. 6 is a block diagram showing details of the signal processing circuit shown in FIG. 5.

FIG. 7 is a timing chart showing operation of the main part of the block diagram shown in FIG. 6.

FIG. 8 is a waveform diagram showing a fluctuation eliminating effect according to this invention.

FIG. 9 is a waveform, diagram showing a fluctuation eliminating effect according to this invention.

FIG. 10 is a waveform of a forward scattered light signal which detected a latex particle (particle diameter of 1 μm) without a fluctuation signal eliminating processing according to this invention.

FIG. 11 is a waveform of a forward scattered light signal which detected a latex particle (particle diameter of 1 μm) by carrying out fluctuation signal eliminating processing according to this invention.

FIG. 12 is a scattergram for when bacteria contained in urine were detected by a flow cytometer according to this invention.

FIG. 13 is a scattergram for when a latex particle (particle diameter of 1 μm) was measured without fluctuation signal eliminating processing according to this invention.

FIG. 14 is a scattergram for when a latex particle (particle diameter of 1 μm) was measured by carrying out fluctuation signal eliminating processing according to this invention.

FIG. 15 is a diagram explaining a waveform of the particle detection signal.

### DESCRIPTION OF THE PRESENTLY PREFERRED EMBODIMENTS

This invention relates to a flow cytometer comprising a sheath flow cell for surrounding a sample solution containing a particle with sheath liquid and forming a sample solution flow, a light source for radiating light to the sample solution flow, a detecting part for detecting optical information from a particle contained in the sample solution flow and converting it to an electric signal, and a signal processing part for processing an electric signal outputted from the detecting part. Further, this cytometer may have an analyzing part for analyzing characteristics of a particle from the electric signal detecting part or signal processing part outputs.

The subjects the flow cytometer measures according to this invention are mainly bacteria and blood cells contained in urine, and particles in various tissues. However, the subjects may be blood cells contained in blood, etc., in a specimen, microorganisms such as yeast and lactic bacteria, and industrial powders.

The flow cytometer according to this invention is useful, in particular when fine particles are analyzed as subjects, or when refractive indices of a sample solution and sheath liquid are different from each other. Further, it is useful, for example, when measuring microscopic bacteria, and when measuring fine water-soluble particles by using a dispersion medium such as alcohol.

In the flow cytometer according to this invention, the sheath flow cell is a flow cell that can form a thin flow of a sample solution with a hydrostatic effect by wrapping a sample solution containing a particle with sheath liquid and flowing it, whereby conventionally known flow cells can be used.

As a light source radiating light to the sample solution flow, a light source that continuously radiates light such as a laser, halogen lamp or tungsten lamp can be used. When using a laser, a gas laser such as an argon laser and a semiconductor laser can be used.

In the detecting portion detecting optical information from particles, photoelectric conversion elements such as photodiodes, phototransistors or photo-multiplier tubes can be used. As optical information, scattered light such as forward scattered light and side scattered light, or fluorescence such as forward fluorescence and side fluorescence may be detected. When detecting fluorescence, particles may be stained by fluorescent dye in advance. For example, when blood cells and tissue are contained in a specimen, the types of blood cells and tissue can be classified by having granules and nucleic acid in tissue react with a specific fluorescent reagent and detecting the fluorescence.

The signal processing part which processes electric signal detecting part outputs can be constituted by using field programmable gate arrays (FPGA) as a programmable digital IC, thereby allowing high speed and real time processing.

The signal processing part may extract a fluctuation signal from an electric signal which the detecting part outputs.

When the fluctuation degree of the fluctuation signal is judged to be large, a warning may be issued to inform that the reliability of the detected particle signal is low.

Further, the signal processing part may correct the electric signal which the detecting part outputs, based on the extracted fluctuation signal, and it may output the electric signal after correction to the analyzing part. Further, correction can be made by a method in which the signal level of the fluctuation signal is subtracted from the signal level of the electric signal.

The signal processing part comprises a fluctuation judging part for judging the fluctuation of a signal from the time variation of the signal level received from the detecting part, a fluctuation signal producing part for producing a fluctuation signal based on the judging result in the fluctuation judging part, and a subtraction part for subtracting the fluctuation signal from the signal received from the detecting part, and may input, the subtracted signal to the analyzing part. The signal processing part constituted in this manner extracts a signal that should be the base level from the detection signals, and the signal level for which the base level is subtracted from the original detection signal level thereby, eliminates the fluctuation signal. If the original detection signal is a low frequency fluctuation signal, the signal level itself is set to be the base level of the detection signal. On the other hand, the base level when the time variation of the signal level is large is a base level immediately before the time variation of the signal level becomes large.

The basic judgment conditions of whether the signal should be a base level are:

1) the variation of signal level per unit time is small;

2) the original signal level is not so large as to exceed the scale; and

3) judgment is not immediately made that it is base level signal even if the signal variation eases after the signal level has sharply varied.

Condition 1 above indicates that the signal for which the time variation of the signal level is small is set to be the base level signal. On the other hand, the signal for which the time variation of the signal level is large is considered to be a case where a particle is detected; therefore, it is not set to be the base level signal.

Condition 2 above indicates that even if there is no variation of the signal level when the signal level exceeds the scale, it is not set to be the base level signal.

Condition 3 above indicates that the signal variation becomes small in the vicinity of the signal waveform peak; however, the signal level at this time is not set to be the base level.

Further, in the signal processing part according to this invention, the subtraction part is provided with a correction part which outputs 0 as a subtraction result when it becomes negative.

The fluctuation judging part may judge that a fluctuation is generated when the variation per unit time in signal level is smaller than the predetermined value.

The fluctuation signal producing part may produce a fluctuation signal by averaging a plurality of signal levels when the fluctuation judging part has continuously judged that the variation per unit time is smaller than the predetermined value.

Further, when the subtraction result at the subtraction part becomes negative, the fluctuation signal producing part may determine the output signal level from the detecting part at that time to be a signal level of the fluctuation signal.

Further, the signal processing part may be provided with a low pass filter for reducing a high frequency noise signal at the previous stage.

The signal processing part does not necessarily carry out the fluctuation signal eliminating processing for all signals which the detecting part outputs. If a scattered light signal and fluorescence signal are detected by the detecting part, the fluctuation signal eliminating processing may be carried out only for the scattered light signal.

The analyzing part analyzes characteristics of particles from the electric signal which are outputted from the detecting part or the signal processing part. For example, there is a method to grasp particle characteristics from the waveform feature of electric signal (e.g., peak level, pulse width, pulse area, etc.). The analyzing part may use a microcomputer or personal computer. The peak level of the forward scattered light signal is a parameter that mainly represents size of particle. The pulse width of the forward scattered light signal is a parameter that represents the length of the particle. If fluorescent dye is applied to a particle in advance, the fluorescent signal is detected. The peak level of the fluorescent signal is a parameter that represents the dye-affinity of the particle. The pulse width of the fluorescent signal is a parameter that represents the length of the dyed portion of a particle. Particles can be fractioned, utilizing distribution of the particle size and the scattergram prepared by extracting these parameters from the electric signals.

Thus, this invention provides a flow cytometer equipped with a signal processing function for efficiently eliminating or reducing the low frequency fluctuation signal of detection signals.

Below, an embodiment of this invention will be explained in detail by referring to the drawings. However, this invention is not limited to this embodiment.

Overall Configuration

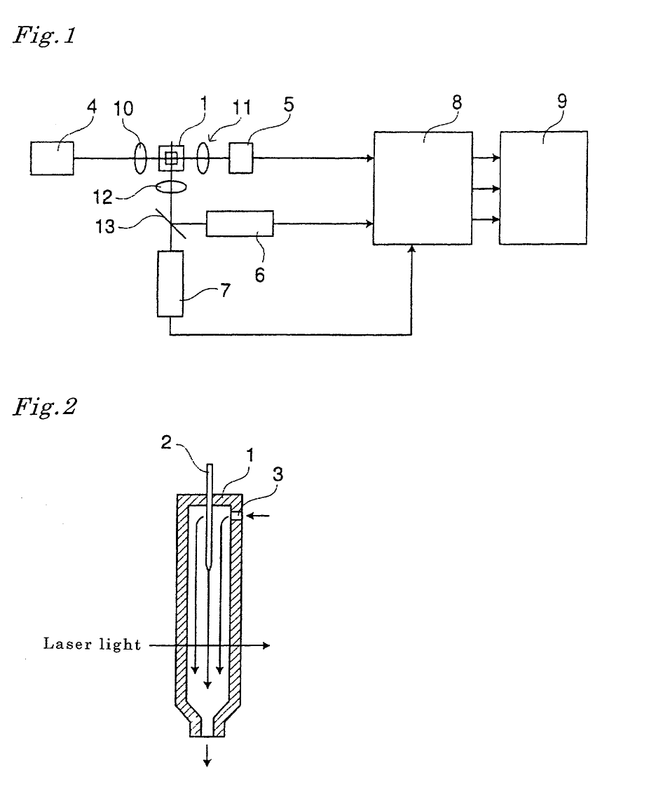

The measuring subjects of the flow cytometer measured in this embodiment are bacteria, blood cells and other various tissues contained in urine, and the sample solution is prepared by applying pre-processing such as dilution and dying to the urine specimen. The prepared sample solution is guided to the sheath flow cell 1 shown in FIG. 1, and is discharged from the end of the nozzle 2 provided on the axis center of the sheath flow cell 1 into the sheath flow cell 1 as shown in FIG. 2. Simultaneously, the sheath liquid is also guided from the sheath liquid guide inlet 3. The sheath liquid surrounds the sample solution, and makes the flow of sample solution thin.

The laser light source 4 radiates laser light to the sample solution flow which is made thin in this manner, and the forward scattered light, side scattered light and side fluorescence of each particle crossing across the radiated area are received and photoelectrically converted by the respective photoelectric conversion elements of the photodiode 5 and photo-multiplier tubes 6 and 7.

In this embodiment, a red semiconductor laser is used as a light source. The sheath flow cell is colorless, transparent, and made of glass. In FIG. 1, the condenser lens 10 condenses laser light on the sheath flow cell 1, and the condensing lens 11 condenses forward scattered light from particles on the photodiode 5. The condensing lens 12 condenses side scattered light and side fluorescence on the dichroic mirror 13. The dichroic mirror 13 reflects the side scattered light to the photo multiplier 6, and transmits the side fluorescence to the photo multiplier tube 7.

The photo detection signal generated as a result of being received by the photoelectric conversion element and photoelectrically converted is waveform-processed by the signal processing circuit 8, and then inputted to the analyzing part 9. At this time, the signal processing circuit 8 functions as a signal processing part in accordance with this invention. Details of the signal processing circuit 8 are described hereinbelow.

The analyzing part 9 calculates parameters such as peak level and pulse width of respective detection signals corresponding to each particle, produces a distribution of particle size and scattergram based on those parameters, and analyzes the particles.

Operation of Delivering Liquid

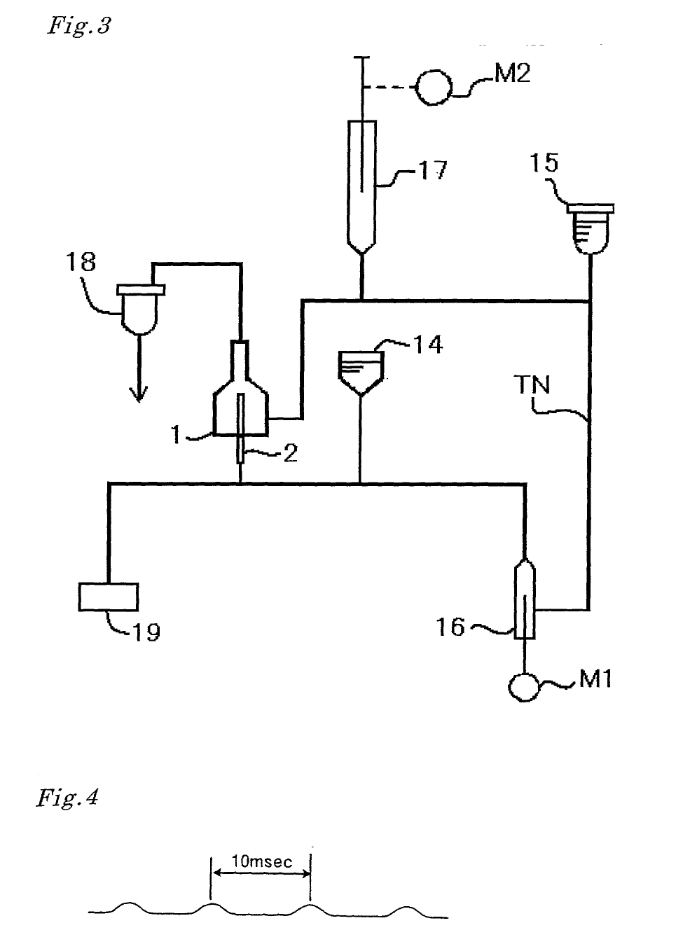

Below, the operation by which a sample solution and sheath liquid are delivered to the sheath flow cell 1 will be described. FIG. 3 schematically shows a liquid system of the flow cytometer of this embodiment. Each part of the sheath flow cell 1, nozzle 2, mix chamber 14, sheath liquid chamber 14, syringe 16, syringe 17, effluent chamber 18 and negative pressure source 20 is connected by the passage TN. At first, in the mix chamber 14, the urine specimen is diluted and dyed, and the sample solution is prepared. The sample solution in the mix chamber 14 is drawn into the passage between the mix chamber 14 and nozzle 2 by the negative pressure source 19. Next, the sample solution is delivered to the sheath flow cell 1 by operation of the syringe 16 driven by the stepping motor M1. Meanwhile, the sheath liquid is stored in the sheath liquid chamber 15 in advance. The sheath liquid in the sheath liquid chamber 15 is drawn into the passage between the syringe 17 and sheath flow cell 1 by the negative pressure source 19. Next, it is delivered to the sheath flow cell I by operation of the syringe 17 driven by the stepping motor M2. The sample solution and sheath liquid which were delivered to the sheath flow cell 1 are discharged to the effluent chamber 18. For both of the stepping motors M1 and M2, PF42T-48G1 G (1/50)-01 manufactured by NIPPON PULSE MOTOR Co., Ltd. is used.

Signal Processing Part

In a method for delivering liquid in which a stepping motor is used as described above, the flow rate of the sample solution slightly changes in synchronization with the drive pulse to rotate the motor. When pulsating flows are generated in the sample solution flow, the base line of the detection signal fluctuates in synchronization with pulsating flows if the refractive index of the sample solution as a measuring subject and refractive index of the sheath liquid are different from each other. FIG. 4 shows a manner in which the base line of the scattered light detection signal is fluctuating. If the baseline of the particle detection signal fluctuates, the characteristic parameters cannot be obtained correctly. This problem applies not only to a scattered light detection signal but also to a fluorescence detection signal. The signal processing circuit 8 to eliminate this kind of fluctuation signal is described below. The signal processing circuit 8 functions as a signal processing part of the invention.

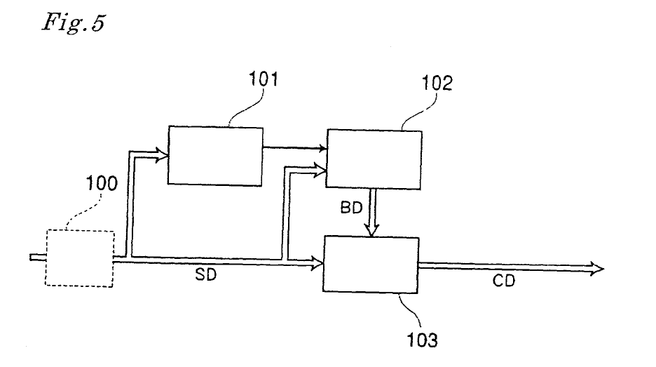

FIG. 5 shows a basic configuration for the signal processing circuit 8. The original signal waveform data SD is a waveform, sampling data sequence to which the analog particle detection signal is A/D converted with a sampling frequency which is sufficiently higher than the signal frequency.

The base signal judgment circuit 101 functions as a fluctuation judging part in accordance with this invention. That is, for the original signal waveform data SD, whether the above conditions 1, 2- and 3 are satisfied is judged by the base signal judging circuit 101. If it is determined that these conditions are satisfied, it is judged to be a base signal. The original signal data that were satisfactorily judged are taken into the base signal producing circuit 102. The base signal producing circuit 102 functions as a fluctuation signal producing part in accordance with this invention.

In the base signal producing circuit 102, the original signal data which were judged to be a base signal previously are also maintained, the signal data that should be a base signal are produced from a plurality of latest signal data that were judged to be base signals. This allows extraction accuracy of base signals for which the level should not inherently change to be changed for enhancement.

The original signal data and the produced base signal data are inputted to the subtraction part, that is, subtracter 103. The signal data BD is subtracted from the original signal data base SD, and the result is outputted as a fluctuation signal eliminating data CD. However, if the result of the subtraction is negative, it is set to 0. The above processing is carried out to the sequentially inputted signal waveform data during measurement in real time.

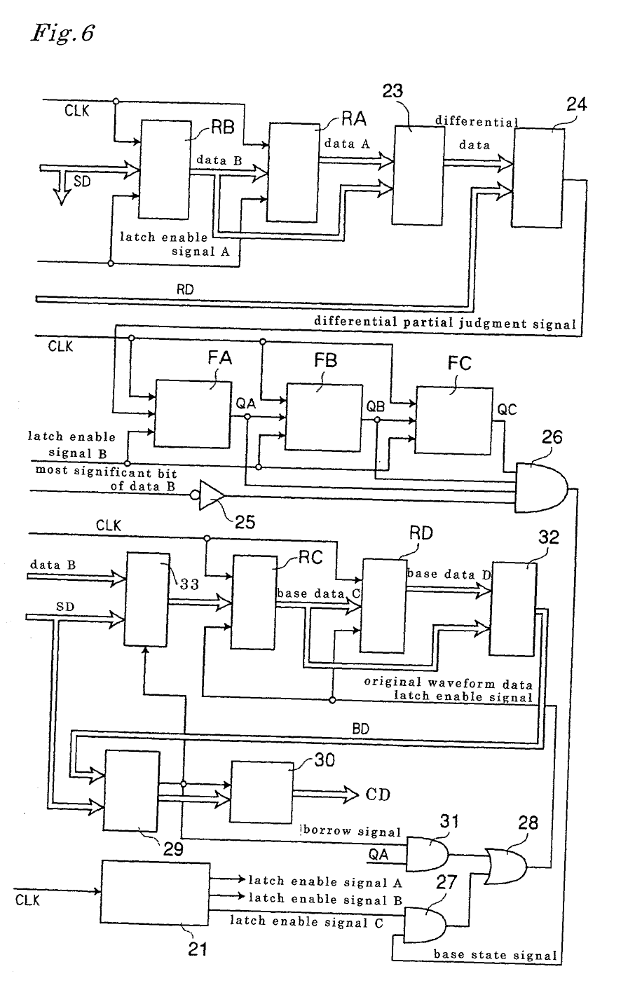

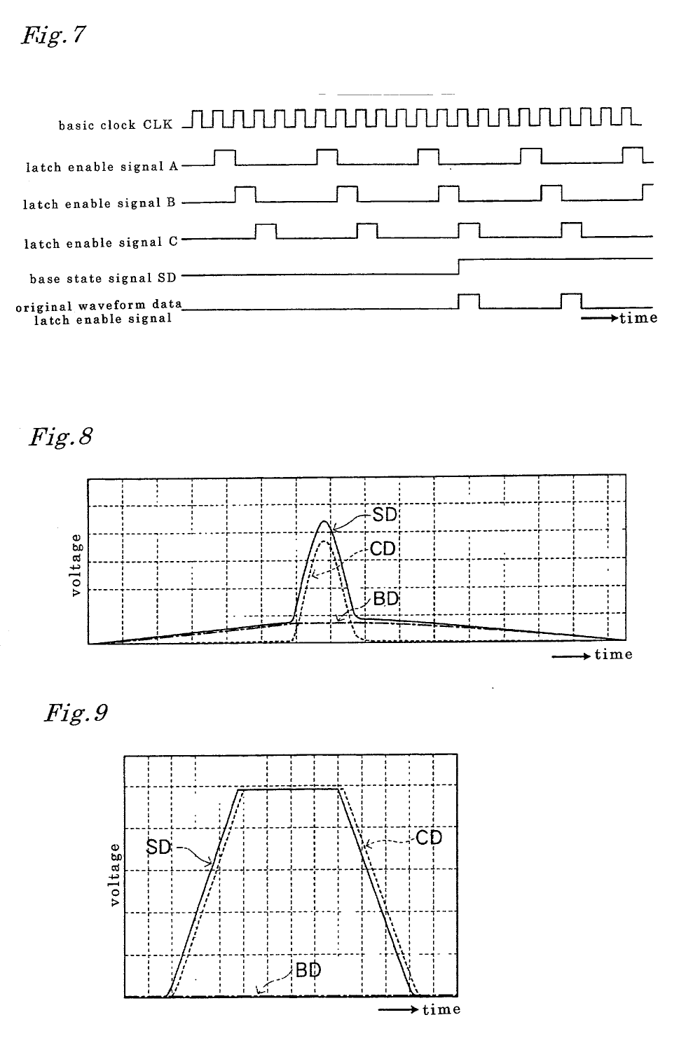

A specific example of the signal processing circuit 8 constituted by using FPGA will be described with reference to block diagram shown in FIG. 6 and timing chart shown in FIG. 7. This embodiment checks variation of the original waveform data at intervals of every 5 clocks of basic clock CLK which is a waveform sampling clock.

The latch enable signal generator 21 makes the latch enable signal A active at intervals of every 5 clocks of basic clock CLK, and latches the original waveform data SD latched in the register RB into the register RA, and simultaneously latches the original waveform data SD into the register RB.

The data A and data B latched into these two registers RA and RB are waveform data that have a time difference of 5 clocks of the basic clock. The differential device 23 calculates a difference between these two pieces of data, and outputs the calculation result as differential data.

This differential data is compared with differential partial judgment specified data RD by the comparator 24. If the differential data is below the differential partial judgment specified data RD, the comparator 24 turns the differential partial judgment signal showing a state where variation of the wave data is small to high, and outputs it.

The differential partial judgment signal from the comparator 24 is held in the flip flop FA as a judgment signal QA by the latch enable signal B that lays behind the latch enable signal A by 1 clock.

The judgment signal QA that was held in the flip flop FA by the next latch enable signal B is held in the flip flop FB as a judgment signal QB. Simultaneously, the latest differential partial judgment signal is held in the flip flop FA as a judgment signal QA.

Further, the judgment signal QB that was held in the flip flop FB by the next latch enable signal B is held in the flip flop FC as a judgment signal QC, and the judgment signal QA that was held in the flip flop FA by the next latch enable signal B is held in the flip flop FB as a judgment signal QB. Simultaneously, the latest differential partial judgment signal is held in the flip flop FA as a judgment signal QA.

Thus, whether variation of waveform data is small is judged by every 5 clocks of the basic clock. The result of the judgment is held in flip flop FA through FC.

The embodiment is established, wherein if variation of waveform data between 5 clocks of the basic clock is judged to be small three times consecutively, and the most significant bit of waveform data B latched in the register RB is 0—that is, if the waveform data B is less than ½ of the full scale level—the presently inputted signal level is set to the base signal level of the detection signal level.

Accordingly, when all outputs of the inverter 25 and flip flop FA, FB and FC are high, the output signal of the AND gate 26—that is, the base state signal—becomes active.

When the base state signal becomes an active state, the AND gate 27 and OR gate 28 become active by the latch enable signal C that lays behind the latch enable signal B by one clock. The original waveform data is drawn into the register RC.

Further, the waveform data held in the register RC are transferred to the register RD by the next latch enable signal C, and the latest original waveform data are held in the register RC.

In this embodiment, the latest two original waveform data when the base state signal is in an active state—that is, two pieces of waveform data drawn into the register RC and register RD—are added and averaged by addition averaging operator 32, and the resultant obtained data BD which are set to the base data BD.

The base data BD produced as above are inputted to the subtracter 29, which subtracts the base data value from the original waveform data. If the result of the subtraction is negative, the transformer 30 forcedly makes it 0 and then finally outputs it as fluctuation eliminating data CD.

Further, in this embodiment, if the above subtraction result becomes negative, the selector 33 outputs the original waveform data SD. Simultaneously, if the variation of the latest waveform data is judged to be small—in other words, judgment signal QA held in the flip flop FA is High—the AND gate 31 and OR gate 28 become active, and the latest original waveform data SD from the selector 33 are drawn into the register RC, and immediately the value of the base data BD is renewed.

By the above digital signal processing, the low frequency fluctuation signal can be eliminated.

In order to eliminate the low frequency fluctuation signal, this embodiment is based on a consideration that the variation signal level per unit time is periodically checked, and the signal whose variation is small is eliminated as a fluctuation signal. Therefore, if the particle detection signal contains high frequency noise, the fluctuation signal may not be properly eliminated. In such a case, as shown in FIG. 5, a low pass filter 100 for reducing the high frequency noise can be provided as pre-processing before carrying out the fluctuation signal eliminating processing described above. For this low pass filter 100, a method employing a filter by conventional analog signal processing or by digital signal processing can be adopted.

Analyzing Part

The particle detection signal to which fluctuation signal eliminating processing was applied by the signal processing circuit 8 is transmitted to the analyzing part 9. The analyzing part 9 extracts parameters showing characteristics of the particles from the particle detection signal, produces a scattergram by properly combining a plurality of parameters, and analyzes particles contained in a specimen.

The peak level of the forward scattered light signal (FSC) is a parameter that mainly shows the size of the particle. The pulse width of the forward scattered light signal (FSCW) is a parameter that shows the length of the particle. If fluorescence dying is applied to the particle in advance, the fluorescence signal is detected. The peak level of the fluorescence signal (FL) is a parameter that shows the dye-affinity of the particle. The pulse width of the fluorescence signal (FLW) is a parameter that shows the length of the dyed portion of a particle.

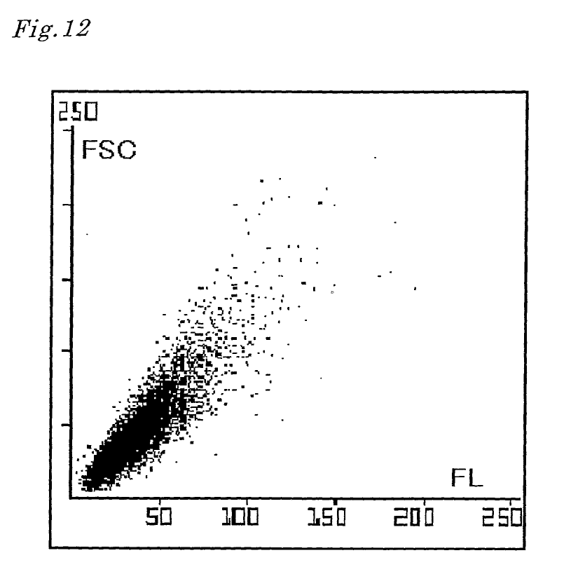

FIG. 12 shows an example of a scattergram prepared by the flow cytometer according to this embodiment. This scattergram takes the peak level of the forward scattered light signal (FSC) on the vertical axis, the peak level of the fluorescence signal (FL) on the horizontal axis, and is used for detecting bacteria contained in urine. It is understood that detected bacteria appear on the scattergram in a manner of forming a group. By setting in advance the area on the scattergram where bacteria are thought to appear, the number of bacteria can be calculated from the number of particles in the area.

Comparison of Waveform Diagram (1)

Effects of the fluctuation signal eliminating processing according to the invention will be explained below.

FIG. 8 is a waveform diagram for a case wherein the forward scattered light signal which detected a particle is simulated, and shows an example when the particle detection signal is on the fluctuation signal. The original waveform data SD are shown by a solid line, and the base data BD calculated in a process of the fluctuation signal eliminating processing are shown by a dashed line. As a result of the fluctuation signal eliminating processing, the signal level of the base data BD is subtracted from the signal level of the original waveform data SD, and only the part of the particle detection signal is extracted as a fluctuation signal eliminating data CD.

FIG. 9 is a waveform diagram for a case wherein the signal level of the forward scattered light signal exceeds the scale. The base data BD (shown by a dashed line) calculated from the original waveform data SD (shown by a solid line) are always maintained at a low value, and it is understood that they do not set the part, of which the level did not change by the signal exceeding the scale, as a base signal level.

Comparison of Waveform Diagram (2)

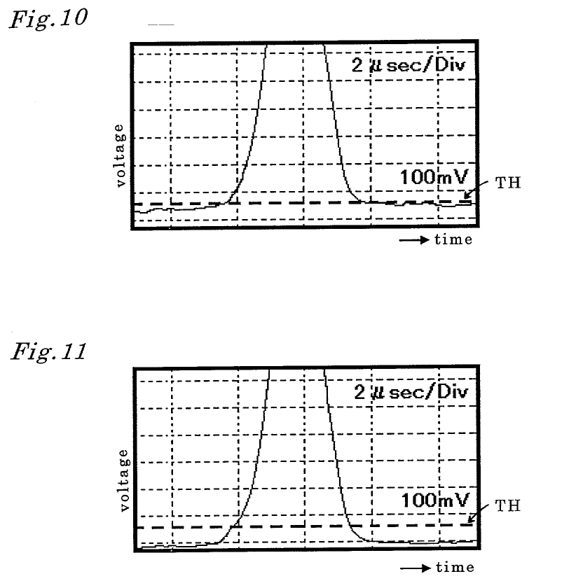

FIG. 10 and FIG. 11 are waveform diagrams of forward scattered light signals obtained by flow cytometer measurements of this embodiment. In both measurements, suspension liquid of a latex particle (particle diameter of 1 μm) was used as sample solution. In the measurement in FIG. 10, fluctuation signal eliminating processing was not carried out. For that reason, the signal base line rose to near the threshold TH under the influence of the fluctuation signal. On the other hand, in FIG. 11, the signal level of baseline is maintained at a low value as a result of the fluctuation signal eliminating processing.

Such a fluctuation signal eliminating processing has a similar effect not only to scattered light detection signal, but also to the fluorescence detection signal.

Comparison of Scattergram

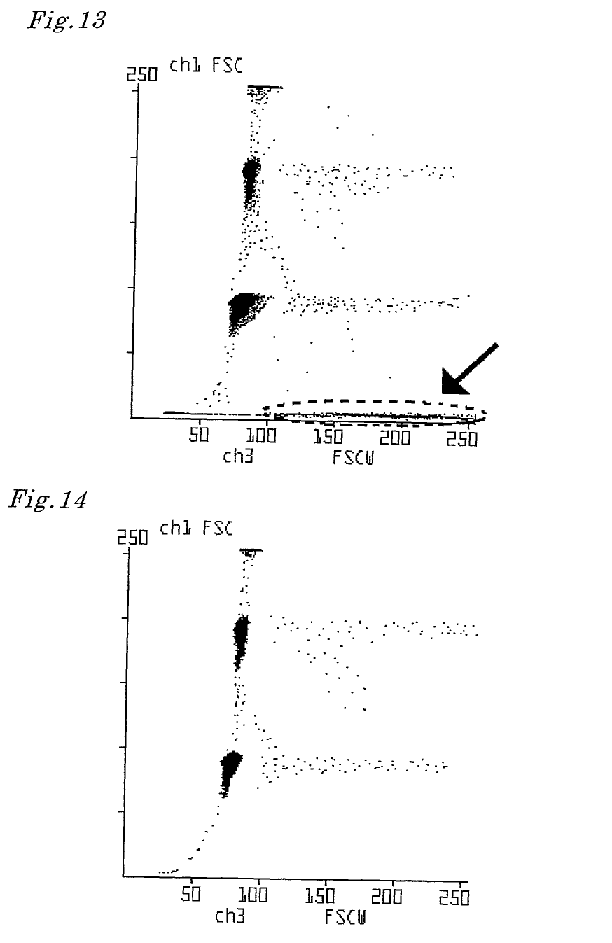

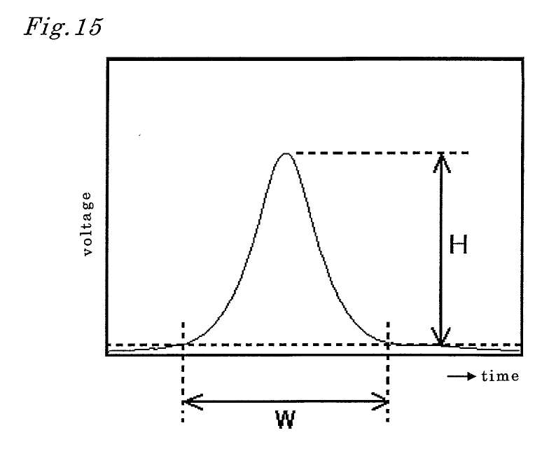

The effect of the fluctuation signal eliminating processing according to the invention will be explained below by using the scattergram. FIG. 13 shows a scattergram produced by measuring particles without carrying out fluctuation signal eliminating processing. In contrast, FIG. 14 shows a scattergram produced by measuring particles while carrying out fluctuation signal eliminating processing. The scattergrams of both FIG. 13 and FIG. 14 have the forward scattered light peak level (FSC) on the vertical axis, and the forward scattered light pulse width (FSCW) on the horizontal axis. In both cases, the measured particles were latex particles (particle diameter of 1 μm).

On the scattergram in FIG. 13, many dots are plotted in an area enclosed by a broken line (the forward scattered light peak level (FSC) is at a low value, and forward scattered light pulse width (FSCW) is in a broad range). This shows the fluctuation signal that was detected by confusion with the particle signal when the fluctuation signal exceeded the threshold. The plot by detection mistakes shown in the scattergram in FIG. 13 is not seen in the scattergram in FIG. 14.

According to this invention, by providing a function to eliminate or reduce the fluctuation signal of a low frequency from a particle detection signal, the fluctuation signal caused by pulsating flows of the sample solution or sheath liquid can be reduced in the flow cytometer, which employs a method for delivering sample solution and sheath liquid by using a stepping motor, even when the refractive indices of the sample solution and sheath liquid differ from each other. Further, the particle detection signals can be correctly recognized so as to carry out signal processing.

Furthermore, the signal processing part according to this invention can be realized by digital signal processing. Therefore, the following advantages result in comparison to a simple analog filter:

1) Even when the detection signal exceeds scale because the particle size is large, only the fluctuation signal can be reduced.

2) There is no variation of fluctuation signal reducing characteristics and no aging change.

3) This can be easily achieved by FPGA which is a programmable digital IC, and allows reduction of the circuit mounting area.

The flow cytometer of the embodiment was intended for measurement of bacteria in urine; however, this invention is applicable to other measuring subjects. It was described previously that it is useful even when measuring water-soluble fine particles by using a dispersion medium such as alcohol. In addition, the measuring subjects may be blood cells in blood, microscopic organisms such as yeast and lactic bacteria, or industrial powders, etc.

This embodiment is constituted such that the signal processing part corrects the electric signal which the detecting part outputted on the basis of the fluctuation signal extracted in the signal processing part. The analyzing part analyzes the signal after being corrected. However, it is not necessarily required to be constituted in this manner. For example, correction can be made at the analyzing stage in the analyzing part on the basis of the fluctuation signal extracted by the signal processing part.

What is claimed is:

1. A flow cytometer, comprising:
a sheath flow cell for forming a sample solution flow by surrounding sample solution containing particles with sheath liquid;
a light source for radiating light to the sample solution flow;
a detecting part for detecting optical information from particles contained in the sample solution flow and converting it to electric signals; and
a signal processing part for extracting fluctuation signals from the electric signals which the detecting part outputs.

2. The flow cytometer according to claim 1, wherein the electric signals which the detecting part outputs are corrected on the basis of the fluctuation signals.

3. The flow cytometer according to claim 1, wherein the signal processing part eliminates signal level of the fluctuation signals from the signal level of the electric signals which the detecting part outputs, and then outputs.

4. The flow cytometer according to claim 1, further comprising a syringe for delivering the sheath liquid to the sheath flow cell, wherein the syringe is driven by a stepping motor.

5. The flow cytometer according to claim 1, wherein the optical information is scattered light.

6. The flow cytometer according to claim 1, wherein the optical information is fluorescence.

7. The flow cytometer according to claim 1, further comprising an analyzing part, wherein the analyzing part extracts parameters showing characteristics of particles from the signals inputted by the signal processing part, and produces a scattergram by combining a plurality of parameters.

8. The flow cytometer according to claim 1, wherein the sample solution is prepared by using urine.

9. The flow cytometer according to claim 1, wherein the particle of the detecting subject is bacteria.

10. A flow cytometer, comprising:
a sheath flow cell for forming a sample solution flow by surrounding a sample solution containing particles with sheath liquid;
a light source for radiating light to the sample solution flow;
a detecting part for detecting optical information from particles contained in the sample solution flow and converting the information to electric signals; and
a signal processing part for eliminating fluctuation signals from the electric signals which the detecting part outputs.

11. The flow cytometer according to claim 10, further comprising a syringe for delivering the sheath liquid to the sheath flow cell, wherein the syringe is driven by a stepping motor.

12. The flow cytometer according to claim 10, wherein the optical information is scattered light.

13. The flow cytometer according to claim 10, wherein the optical information is fluorescence.

14. The flow cytometer according to claim 10, wherein the analyzing part extracts parameters showing characteristics of particles from the signals inputted by the signal processing part, and produces a scattergram by combining a plurality of parameters.

15. The flow cytometer according to claim 10, wherein the sample solution is prepared by using urine.

16. The flow cytometer according to claim 10, wherein the particle of the detecting subject is bacteria.

17. A flow cytometer, comprising:
a sheath flow cell for forming a sample solution flow by surrounding a sample solution containing particle with sheath liquid;
a light source for radiating light to the sample solution flow;
a detecting part for detecting optical information from particles contained in the sample solution flow and converting the information to electric signals;
a signal processing part for processing electric signals which the detecting part output, and input the signals into an analyzing part; and
an analyzing part for analyzing characteristics of particles from electric signals which the signal processing part outputs;
wherein the signal processing part is provided with a fluctuation judging part for judging fluctuation of signals from the time variation of a signal level received from the detecting part, a fluctuation signal producing part for producing a fluctuation signal based on the judging result of the fluctuation judging part, and a subtracting part for subtracting a fluctuation signal from the signal received from the detecting part, and inputs the subtracted signal into the analyzing part.

18. The flow cytometer according to claim 17, wherein the subtracting part is provided with a correcting part for outputting the subtraction result as 0 when the result is negative.

19. The flow cytometer according to claim 17, wherein the fluctuation judging part judges to be fluctuation when signal level variation per unit time is smaller than the predetermined value.

20. The flow cytometer according to claim 17, wherein the fluctuation signal producing part sets the output signal level of the detecting part at the time as a signal level of the fluctuation signal when the subtraction result of the subtracting part becomes negative.

21. The flow cytometer according to claim 17, wherein the signal processing part is provided with a low pass filter for reducing a high frequency noise signal at the previous stage.

22. The flow cytometer according to claim 19, wherein the fluctuation signal producing part produces a fluctuation signal by averaging a plurality of signal levels when the fluctuation judging part consecutively judges that variation per unit time is smaller than the predetermined value.

23. The flow cytometer according to claim 17, further comprising a syringe for delivering the sheath liquid to the sheath flow cell, wherein the syringe is driven by a stepping motor.

24. The flow cytometer according to claim 17, wherein the optical information is scattered light.

25. The flow cytometer according to claim 17, wherein the optical information is fluorescence.

26. The flow cytometer according to claim 17, wherein the analyzing part extracts parameters showing characteristics of particles from the signal inputted by the signal processing part, and produces a scattergram, by combining a plurality of parameters.

27. The flow cytometer according to claim 17, wherein the sample solution is prepared by using urine.

28. The flow cytometer according to claim 17, wherein the particle of the detecting subject is bacteria.
